(19) United States
(12) Patent Application Publication
(10) Pub. No.: US 2012/0256019 A1
(43) Pub. Date: Oct. 11, 2012

(54) Diffusing Device for Liquids

(76) Inventor: Arno Drechsel, Lienz (AT)

(21) Appl. No.: 13/510,414

(22) PCT Filed: Nov. 22, 2010
(86) PCT No.: PCT/IB2010/055342

§ 371 Date: Jun. 25, 2012

(30) Foreign Application Priority Data
Nov. 21, 2009 (IT) VI2009A000280

(51) Int. Cl. B05B 1/00

(52) U.S. Cl. 239/589

(57) ABSTRACT

A sprinkler head comprising an elongated main body (2), a deflecting member (4) coupled thereto for deflecting the water flow and sprinkling it outwards, and a stabilizing mass (3). The main body (2) has a fixing portion (18), with a plurality of snap-fit fastening members (19, 19′, 19″). The stabilizing mass (3) has at least one engaging member (20) which is designed to interact with the fastening members (19, 19′, 19″) for unremovably fixing the stabilizing mass (3) to the periphery of the fixing portion (18). The fastening members (19, 19′, 19″) and the engaging member (20) are mutually configured to allow the stabilizing mass (3) to be axially snap-fitted onto said fixing portion (18) and prevent it from being later axially disengaged therefrom.

### FIELD OF THE INVENTION

The present invention generally finds application in the field of irrigation systems for agricultural and industrial applications, and particularly relates to a liquid sprinkler head, particularly for use in “center pivot” irrigation systems.

### BACKGROUND ART

In irrigation systems, sprinkler heads are known to be used to distribute a flow of irrigation water around them.

Particularly, in so-called “center pivot” systems, consisting of sections that may be even hundreds of meters long, with multiple liquid outlet pipes extending therefrom, a plurality of sprinkler devices, known as “sprinkler heads” are mounted downstream from pressure regulators.

These sprinkler heads consist of a main body that comprises an inlet for irrigation water, a nozzle that directs the liquid jet and a specially-shaped sprinkling plate, usually of oscillating type.

One of the problems associated with the use of sprinklers in “center pivot” systems is that they are prone to oscillations and vibrations, caused by the flow itself and the wind, when they are coupled to down pipes. As a result, they can cause damages to the structure of the irrigation system.

In order to minimize such vibrations and oscillations, stabilizing masses are usually employed, which are coupled in various manners to the main body.

U.S. Pat. No. 6,176,440 discloses a sprinkler head with a stabilizing mass, in which the latter is adapted to be removably engaged with internal threads formed at the lower end of the main body.

Such prior art sprinkle involves difficult and expensive manufacture, due to the large number of its parts and the difficult assembly thereof. Also, it is equipped with various interchangeable stabilizing masses, which make its use inconvenient and difficult.

Also, this prior art solution is exposed to strong vibration.

This necessarily involves the use of relatively large masses, which considerably increases both manufacturing and sale costs. On the other hand, for effective vibration damping, the stabilizing mass must be connected below the instability point between the two oscillation generating elements, to lower as much as possible the center of gravity of the system.

### DISCLOSURE OF THE INVENTION

The object of this invention is to overcome the above drawbacks, by providing a sprinkler head that has a simple and efficient construction and is relatively cost-effective.

Another object of the present invention is to provide a sprinkler head that requires a relatively light stabilizing mass.

Another object of the present invention is to provide a sprinkler head that allows a constant distance to be maintained between the deflecting plate and the jet delivery nozzle, thereby ensuring optimal operation, even after long use.

These and other objects, as more clearly shown hereinafter, are fulfilled by a sprinkler head, particularly for use in “center pivot” irrigation systems, which may comprise an elongated main body defining a first longitudinal axis with an inlet for irrigation water and a nozzle for directing water flow, a deflecting member coupled to the main body and facing the nozzle, for deflecting water flow and sprinkling it outwards, and a stabilizing mass.

In a general manner, the deflecting member may be mounted to the main body in a fixed manner, so that it can maintain its position when it is hit by the water jet from the nozzle, or in a movable manner, so that an irregular rotational and translational motion may be imparted to it when it is hit by the water jet.

The main body may have a fixing portion with a plurality of snap-fit fastening members, whereas the stabilizing mass may have at least one engaging member designed to interact with the fastening members for unremovably fixing the stabilizing mass to the periphery of the fixing portion.

The sprinkler head with the stabilizing mass unremovably fixed to the main body has a very convenient use, as the user is not required to purchase and keep additional stabilizing masses for interchange purposes.

Conveniently, the fastening members and the engaging member may be mutually configured to allow the stabilizing mass to be axially snap-fitted onto the fixing portion and prevent it from being later axially disengaged therefrom.

This allows simpler and quicker assembly of the sprinkler head, with a very little margin of error. A quicker assembly of the sprinkler head reduces the costs of the whole production cycle, and obviously the final cost of the sprinkler head.

The fixing portion with which the stabilizing mass is designed to be fixed, may be in any position on the main body.

In a particularly preferred, non exclusive embodiment, the main body may comprise a first end portion which includes the irrigation water inlet and a second end portion opposite thereto which includes the fixing portion.

Thus, the stabilizing mass may be fixed to the main body at the lower end thereof, for maximized oscillation damping.

Advantageously, a main body may be provided in which the second end portion may have a hollow interior, and hence have a tubular shape, with a bottom wall.

Conveniently, the stabilizing mass may have a small weight. Advantageously, such stabilizing mass may have a weight of 0.5 pounds or less.

On the other hand, the fastening members and the engaging member may be mutually configured to allow the stabilizing mass fixed to the fixing portion to be coplanar with the bottom wall or above it.

Advantageous embodiments of the invention are defined in accordance with the dependent claims.

### BRIEF DESCRIPTION OF THE DRAWINGS

Further features and advantages of the invention will be more apparent from the detailed description of a preferred, non-exclusive embodiment of a sprinkler head of the invention, which is described as a non-limiting example with the help of the annexed drawings, in which:

FIG. 1 is a partially exploded perspective view of one embodiment of a sprinkler head of the invention;

FIG. 2 is a partially exploded sectional view of one embodiment of a sprinkler head of the invention;

FIG. 3 is an assembled sectional view of the embodiment of the sprinkler head of the invention as shown in FIG. 2;

FIG. 4 is an enlarged perspective broken away view of certain details of FIG. 3;

FIGS. 5a, 5b, 5c and 5d are enlarged sectional views of certain operating steps of the assembly of the stabilizing mass 3 and the main body 2.

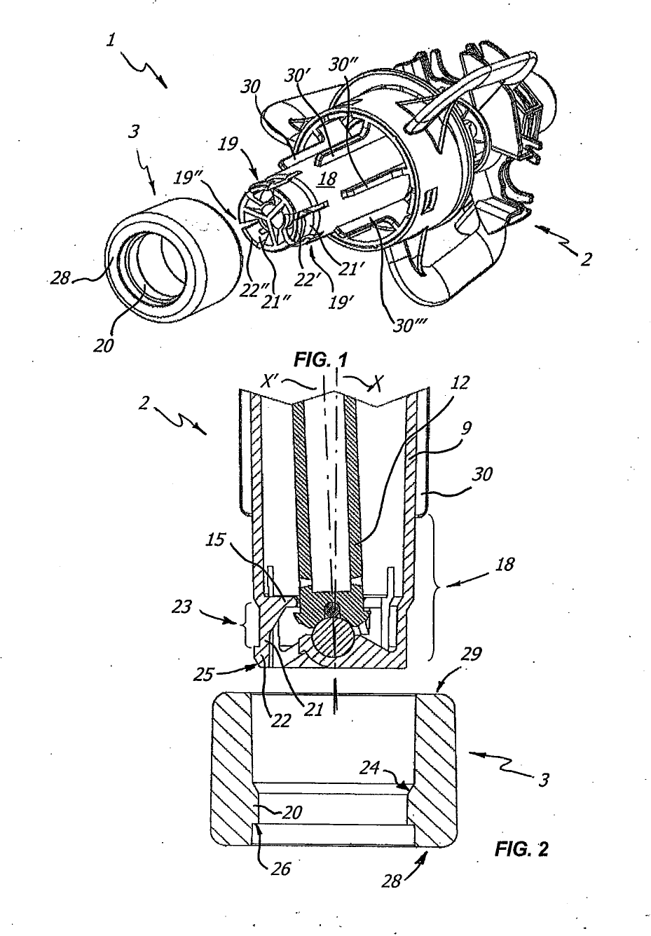

### DETAILED DESCRIPTION OF A PREFERRED EMBODIMENT

Referring to the above figures, the sprinkler head of the invention, generally designated by numeral 1, may be used to distribute irrigation water over surfaces, possibly having a large surface area, such as in the irrigation of agricultural areas.

The sprinkler head 1 may be connected, as is known per se, to a hydraulic system, particularly of the center pivot type, on a down pipe connected to the main line and downstream from a pressure regulator which may be, for example, as disclosed in the Italian Patent application VI2009A000170 by the present Applicant.

The liquid sprinkler head may basically comprise a main body 2, that may be at least partially hollow, a stabilizing mass 3 and a deflecting member 4 coupled to the main body 2.

Conveniently, the main body and/or the deflector member may be at least partially as disclosed in one or more of the International Patent Applications PCT/IB2009/053222, PCT/IB2009/053223 or PCT/IB2009/053221, by the present Applicant.

Particularly, the main body 2, that may be of elongated type to define a first preferably vertical longitudinal axis X, may have a first upper end 5, having an upper inlet passage 6 for irrigation water, and a second lower end portion 7, opposite to the first end, that may have a hollow interior to define a tubular end portion with a substantially cylindrical side wall 9 and a bottom wall 10.

The inlet passage 6 may be in fluid connection with a fixed or removable converging nozzle 8, which is coupled in a known manner to the main body 2, and accelerates the incoming water flow to direct it against the deflecting member 4.

The latter may comprise an upper plate 11 facing the nozzle 8 and specially shaped to receive the water flow therefrom and direct it outwards.

The plate 11 may be integrally coupled to a lower stem 12 which defines a second longitudinal axis X′ and is held in the second lower end portion 7, lying with its bottom on the bottom wall 10 thereof.

More particularly, the stem 12 and the bottom wall 10 may comprise a lower contact surface 13 and an upper contact surface 14 respectively, which are in mutual mating contact, thereby allowing rotation of the stem 12 relative to the bottom wall 10 and oscillation of the second axis X′ relative to the first axis X, as a result of the water jet impinging upon the plate 11.

In order to constrain rotation of the stem 12 at its bottom about a central point of the bottom wall 10, the latter may be axially and radially retained by axial and/or radial retaining members 15, 15′, e.g. three equally angularly spaced members, to prevent both excessive upward translation of the stem 12, and radial displacement thereof during rotational and translational motion.

The axial and/or radial retaining members 15, 15′ may comprise appendices radially extending from the side wall 9 of the tubular end portion 7 near the bottom wall 10, and may have such a length as to radially interact with the stem 12 and hold it in a substantially central position relative to the bottom wall, so that the axis X′ constantly rotates about the vertical axis X with no radial displacement.

The radial and axial retention of the stem 12 is also ensured by the particular hemispherical shape of its end, which is adapted to engage in a matingly shaped seat formed on the bottom wall 10.

On the other hand, each axial and radial retention appendix 15, 15′ may axially interact with a radial edge 16 that is formed at the periphery of the stem 12 near its contact surface 13, to prevent upward translation thereof.

Advantageously, an annular elastomeric member 17 may be provided near the plate 11 and preferably slightly therebelow, between the cylindrical wall 9 of the tubular end portion 7 and the stem 12. Such member 17 will be used to damp the vibrations caused by the impact of the stem 12 against the wall 12, and to control at the same time the rotation speed thereof.

This will minimize the vibrations of the system, and will thus allow the use of relatively light stabilizing masses 3.

In a particularly preferred embodiment, the stabilizing mass 3 may have a weight of 0.5 pounds or less.

The stabilizing mass is unremovably fixed to the main body 2.

For this purpose, the latter may have a fixing portion 18 with a plurality of snap-fit fastening members 19, 19′, 19″, which are designed to interact with an engaging member 20 formed within the stabilizing mass 3 to fix the latter peripherally to the fixing portion 18.

Advantageously, in order to minimize relative radial displacements, the stabilizing mass 3 may have a substantially annular shape with a first inner diameter Di₁ substantially coincident with the first outer diameter De₁ of the fixing portion 18.

On the other hand, the engaging member 20 of the stabilizing mass 3 may substantially consist of an inner annular projection having a second inner diameter Di₂ smaller than the first inner diameter Di₁.

Conveniently, for proper axial coupling, the fastening members 19, 19′, 19″ may have a shape that substantially mates the shape of the annular projection 20.

Namely, such members will be in such shape and/or size arrangement as to allow the stabilizing mass 3 to be axially snap-fitted onto the fixing portion 18 and prevent it from being later axially disengaged therefrom.

For this purpose, the fastening members 19, 19′, 19″ may comprise respective elongated appendices 21, 21′, 21″ extending downwards along the axis X of the fixing portion 18, each having an outwardly projecting end tooth 22, 22′, 22′ adapted for snap engagement with the annular projection 20.

The elongated appendices 21, 21′, 21″ may define an outer cylindrical fixing surface 23 having a second outer diameter De₂ substantially coinciding with the second inner diameter Di₂ of the annular projection 20.

Advantageously, as is particularly apparent from FIG. 2, the annular projection 20 may have a first inwardly inclined upper surface 24, which is designed for cooperating with the second inclined surfaces 25 of the end teeth 22, upon axial snap-fit of the stabilizing mass 3 on the fixing portion 18, as better shown hereinbelow.

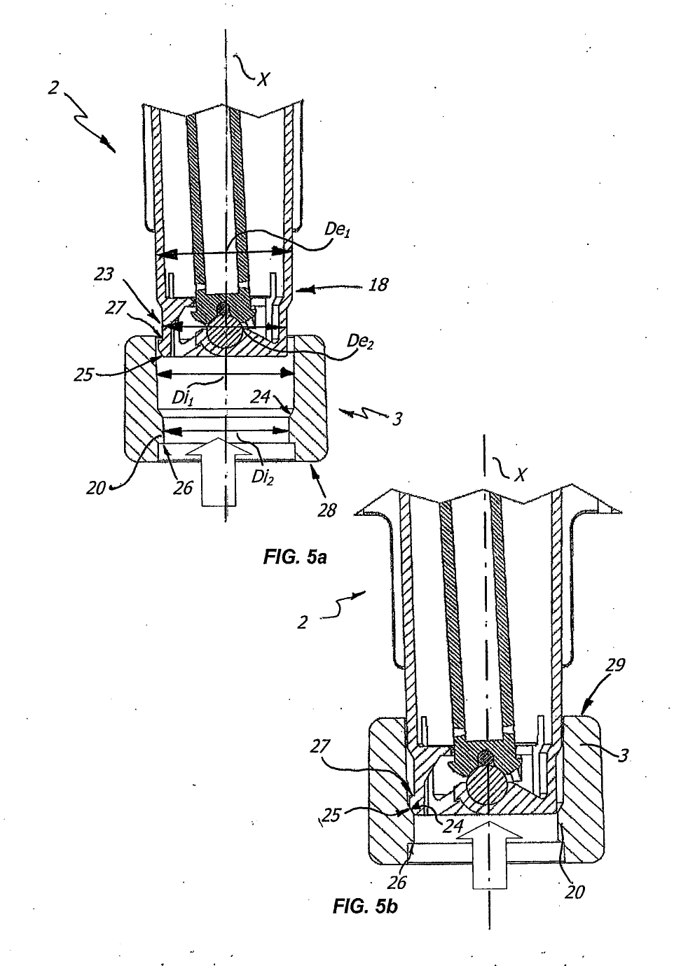

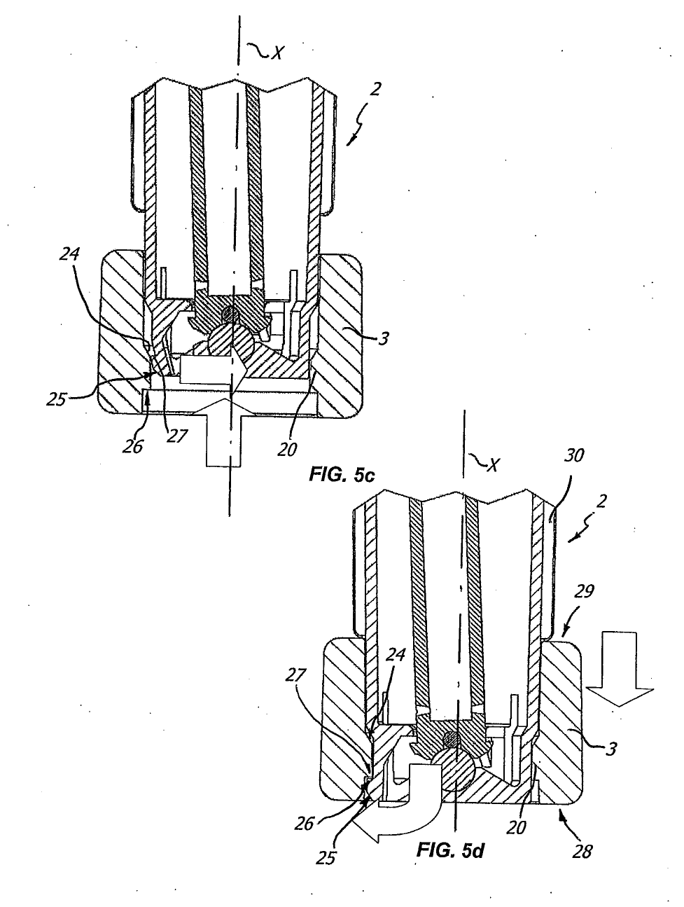

Therefore, one method of making the sprinkler head 1 may include the steps of: providing the main body 2; providing the stabilizing mass 3; aligning the latter and the main body 2 along the axis X so that the first inwardly inclined upper surface 24 of the annular projection 20 remains aligned with the second inclined surfaces 25 of the end teeth 22, as shown in FIG. 5a; axially fitting the stabilizing mass 3 on the fixing portion 18 so that the second inclined surfaces 25 slide on the first upper surface 24 to radially inwardly bend their respective elongated appendices 21, as shown in FIGS. 5b and 5c; sliding the stabilizing mass 3 on the fixing portion 18 to a position in which the fastening members 19, 19′, 19″ are free to return to their original shape, and come to snap engagement with the annular projection 20, as shown in FIG. 5d.

This figure also shows that the flat shape of the surfaces 26 and 27 prevents axial removal of the stabilizing mass 3 from the fixing portion 18.

Advantageously, the step of axially fitting of the stabilizing mass 3 on the fixing portion 18 may be preceded by the step of introducing the stem 12 below the axial and radial retention appendices 15, 15′ to contact with the bottom wall 10.

For this purpose, the fastening members 19, 19′, 19″ may be bent radially outwards, for spacing the axial and radial retention appendices 15, 15′ and allow the stem 12 to be fitted therebetween, with the radial edge 15 below the appendices 15, 15′.

This greatly facilitates assembly of the stabilizing mass 3 on the main body 2 and reduces manufacturing times and costs. The particular mutual configuration of the fastening members 19, 19′, 19″ and the annular projection 20 will further “guide” such assembly and minimize errors.

The material that forms the fastening members 19, 19′, 19″ may have such mechanical characteristics, and particularly such flexural stiffness as to achieve the above results.

Particularly, this material will allow the fastening members 19, 19′, 19″ to bend radially inwards in response to the stress generated upon sliding of the stabilizing mass 3 and then to snap back to the original shape once the mass 3 has been fitted on the fixing portion 18.

In a preferred non-limiting embodiment, the main body 2, and particularly the fastening members 19, 19′, 19″ may be made of a polymeric material. On the other hand, the mass 3 may be made of metal.

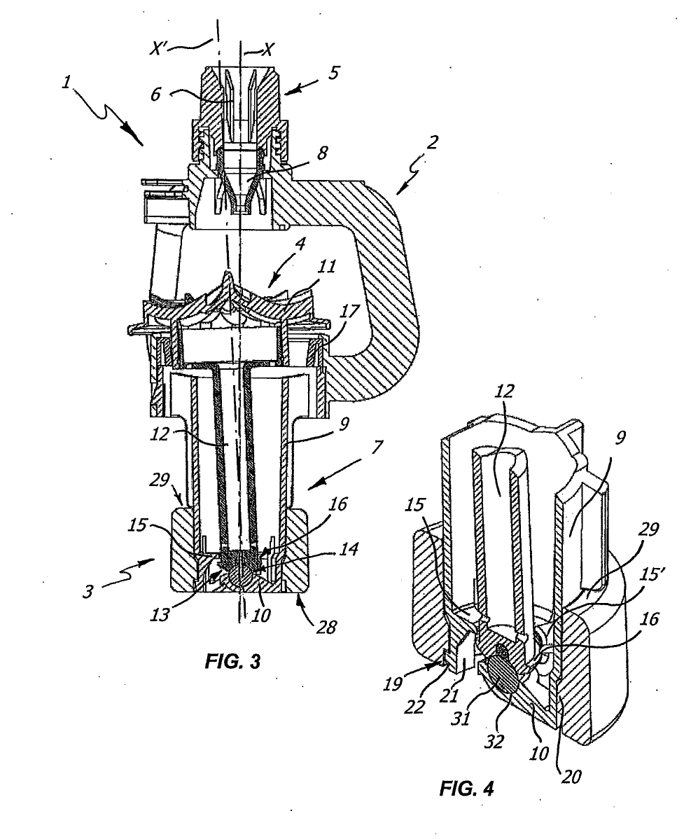

The fastening members 19, 19′, 19″ and the engaging member 20 may be spaced from each other and sized in such a manner that the free bottom end face 28 of the stabilizing mass 3, once the latter has been snap-fitted on the fixing portion 18, remains coplanar with the bottom wall 5, as shown in FIGS. 3 and 4, or above it.

Also, the annular projection 20 may advantageously have a first flat lower surface 26 that may cooperate with second flat upper surfaces 27 of the end teeth 22 to act as a first axial abutment for the stabilizing mass 3, thereby preventing removal thereof from the fixing portion 18 once it has been axially slid thereon.

On the other hand, the lower end portion 7 of the main body 2 may have a plurality of locking members 30, 30′, 30″, opposite located to the end teeth 22, 22′, 22″, to delimit the fixing portion 18.

Advantageously, the locking members 30, 30′, 30″, . . . may cooperate with the second end face 29 of the stabilizing mass 3 to act as a second axial abutment for the latter, once it has been fitted on the fixing portion 18, thereby preventing any axial upward sliding thereof on the main body 2, as is particularly apparent from FIG. 5d.

The contact surfaces 13, 14 may have any shape, without departure from the scope as defined by the annexed claims.

In the configuration of the sprinkler head 1 as shown by way of illustration and without limitation of the invention in FIGS. from 1 to 5d, they will have, for instance, a hemispherical profile. Particularly, the lower contact surface 15 may be defined by the outer surface of a ball 31 received in a special housing 32 formed on the bottom wall 5, whereas the upper contact surface 13 may be defined by a recess formed at the lower end of the stem 12, whose shape mates the shape of the lower contact surface 14.

The above description clearly shows that the invention fulfills the intended objects.

The sprinkler head of this invention is susceptible to a number of changes and variants, within the inventive concept disclosed in the appended claims. All the details thereof may be replaced by other technically equivalent parts, and the materials may vary depending on different needs, without departure from the scope of the invention.

1. A sprinkler head, comprising:
an elongated main body defining a first longitudinal axis with an inlet for the irrigation water and a nozzle for directing the water flow,
a deflecting member coupled to said main body and faced to said nozzle for deflecting the water flow and sprinkling outwards thereof,
a stabilizing mass;
wherein said main body comprises a fixing portion with a plurality of snap-fit fastening members, said stabilizing mass including at least one engaging member susceptible to interact with said fastening members for unremovably fixing said stabilizing mass peripherally to said fixing portion, and
wherein said fastening members and said at least one engaging member are mutually configured to allow the axial snap-fit insertion of said stabilizing mass on said fixing portion and to prevent the subsequent axial disengaging therefrom.

2. Sprinkler head according to claim 1, wherein said fixing portion is substantially cylindrical shaped with a first predetermined outer diameter, said stabilizing mass being substantially annular shaped with a first inner diameter substantially equal to said first outer diameter.

3. Sprinkler head according to claim 2, wherein said at least one engaging member includes an annular inner projection with a second inner diameter lower than said first inner diameter, said fastening members being substantially countershaped with respect to said annular projection.

4. Sprinkler head according to claim 3, wherein said fastening members comprise respective elongated appendices axially extending from said fixing portion, each of said elongated appendices including a respective outwardly projecting end tooth to snap-fit engage said annular projection of said stabilizing mass.

5. Sprinkler head according to claim 4, wherein said annular projection includes a first inwardly inclined surface and a first flat surface opposed thereof, each of said end teeth including a second surface inclined correspondingly to said first inclined surface and a second flat surface opposed thereof, said first inclined surface of said annular projection being designed to cooperate with said second inclined surfaces of said teeth for inwardly radially flexing the respective elongated appendices thereof upon the snap-fit axial inserting of said stabilizing mass on said fixing portion.

6. Sprinkler head according to claim 5, wherein said second flat surfaces of said teeth cooperate with said first flat surface of said annular projection to act as a first axial abutment member for said stabilizing mass inserted on said fixing portion.

7. Sprinkler head according to claim 6, wherein said stabilizing mass includes a first free end face and a second end face opposed thereof, said main body comprising a plurality of locking members opposite to said end teeth along the periphery of said main body for delimiting said fixing portion, said locking members cooperating with said second end face of said stabilizing mass to act as second axial abutment member for the latter inserted on said fixing portion.

8. Sprinkler head according to claim 1, wherein said main body comprises a first end portion which includes said irrigation water inlet and a second end portion opposed thereof which includes said fixing portion.

9. Sprinkler head according to claim 8, wherein said second end portion is hollow and comprises a cylindrical side wall and a bottom wall, said deflecting member comprising an upper plate fixed to a lower stem defining a second longitudinal axis housed into said second hollow end portion, said stem being mounted into said second hollow end portion to allow rotation of said stem relative to said bottom wall and oscillation of said second axis relative to said first axis responsive to the action of the liquid jet on said plate, said second hollow end portion comprising an annular shock-absorbing elastomeric element for absorbing the shocks caused by the impact of said stem against the cylindrical wall, said fastening members and said engaging member being mutually configured in such a manner that said stabilizing mass fixed to said fixing portion remains coplanar to said bottom wall or up thereto.

10. Sprinkler head according to claim 8, wherein said stabilizing mass has a weight equal to or lower than 0.5 pounds.
